(19) United States
(12) Patent Application Publication
(10) Pub. No.: US 2026/0269211 A1
(43) Pub. Date: Sep. 10, 2026

(54) METHOD FOR MANUFACTURING ELECTRODE SHEET AND ELECTRODE SHEET MANUFACTURED THEREBY

(71) Applicant: SK On Co., Ltd., Seoul (KR)

(72) Inventors: Young Jun KIM, Daejeon (KR); Seung Hyeon OH, Daejeon (KR); Seung Yeon JO, Daejeon (KR)

(21) Appl. No.: 19/555,898

(22) Filed: Mar. 4, 2026

(30) Foreign Application Priority Data
Mar. 6, 2025 (KR) 10-2025-0029039

(51) Int. Cl. H01M 4/04; H01M 4/139

(52) U.S. Cl. CPC H01M 4/0435; H01M 4/139

(57) ABSTRACT

The present disclosure relates to a method for manufacturing an electrode sheet, the method including mixing a binder and a volatile solvent using a first mixing device to prepare a binder composite, mixing the binder composite, an electrode active material, and a conductor using a second mixing device to prepare electrode powder, and roll-pressing the electrode powder using a calendering device to prepare the electrode sheet, and an electrode sheet manufactured thereby.

### CROSS-REFERENCE TO RELATED PATENT APPLICATION

The present application claims priority under 35 U.S.C. § 119(a) to Korean patent application number 10-2025-0029039 filed on Mar. 6, 2025, in the Ministry of Intellectual Property, the entire disclosure of which is incorporated by reference herein.

### BACKGROUND OF THE INVENTION

### 1. Field

The present disclosure relates to a method for manufacturing an electrode sheet and an electrode sheet manufactured thereby.

### 2. Description of the Related Art

Generally, an electrode of a lithium secondary battery is manufactured by dispersing an electrode active material, a conductive material, and a binder in a solvent to form slurry, applying the slurry onto a current collector, and then drying the slurry to evaporate the solvent.

Recently, a method for manufacturing an electrode in a dry manner has been proposed. The method for manufacturing the electrode in the dry manner is a method that does not use a solvent, and thus, a drying process for removing the solvent may be omitted. However, the electrode manufactured by this conventional dry method have insufficient tensile strength, and there is a limitation of cracks occurring on its surface.

Thus, there is a high need for a technology that is capable of ensuring the tensile strength of the electrode when manufacturing the electrode in the dry method.

### SUMMARY OF THE INVENTION

An object of the present disclosure is to improve quality of an electrode sheet.

Another object of the present disclosure is to reduce frictional force of electrode powder.

Another object of the present disclosure is to reduce abrasion of equipment for manufacturing an electrode.

Another object of the present disclosure is to reduce manufacturing costs of an electrode sheet.

Another object of the present disclosure is to increase in tensile strength of an electrode sheet.

The present disclosure may be widely applied in fields of green technologies such as electric vehicles, battery charging stations, solar power generation, wind power generation, etc., which use batteries. Furthermore, the present disclosure may be used in eco-friendly electric vehicles, hybrid vehicles, etc., in order to prevent climate change by suppressing air pollution and greenhouse gas emission.

A method for manufacturing an electrode sheet according to the present disclosure includes: mixing a binder and a volatile solvent using a first mixing device to prepare a binder composite; mixing the binder composite, an electrode active material, and a conductor using a second mixing device to prepare electrode powder; and roll-pressing the electrode powder using a calendering device to prepare the electrode sheet.

The method for manufacturing the electrode sheet according to the present disclosure further include aging the binder composite at a preset temperature for a preset time.

In the method for manufacturing the electrode sheet according to the present disclosure, the preset time may be about 6 hours or more.

In an embodiment, the first mixing device may include a blender that accommodating and rotating the binder and the volatile solvent.

In an embodiment, the second mixing device may include a continuous slurry mixer that mixes the binder composite, the electrode active material, and the conductive material.

In an embodiment, the calendaring device may include a plurality of rolls that rotate to move the electrode powder while pressing the electrode powder.

In an embodiment, the roll-pressing of the electrode powder to prepare the electrode sheet may include inputting the electrode powder between rolls of the plurality of rolls, which are disposed at a first interval, and between rolls of the plurality of rolls, which are disposed at a second interval less than or equal to the first interval.

In an embodiment, a speed of each of the rolls disposed at the first interval and a speed of each of the rolls disposed at the second interval may be different from each other.

In an embodiment, at least a portion of the volatile solvent may be volatilized while roll-pressing the electrode powder using the calendaring device.

In an embodiment, a content of the volatile solvent remaining in the electrode sheet roll-pressed using the calendaring may be about 10 ppm to about 100 ppm.

In an embodiment, the volatile solvent may include an isoparaffinic hydrocarbon solvent.

In an embodiment, a boiling point of the volatile solvent may range of about 99° C. to 193° C., a density of the volatile solve ranges of about 0.710 g/cc to about 0.726 g/cc, a viscosity of the volatile solvent may range of about 0.68 mm2/s to about 1.48 mm2/s, and a relative evaporation rate of the volatile solvent may range of about 5.7 to about 370 when an evaporation rate of n-butyl acetate (n-BuAc) is about 100.

In an embodiment, with respect to 100 parts by weight of the binder composite, the binder may have about 50 parts to about 80 parts by weight, and the volatile solvent may have about 20 parts to about 50 parts by weight.

According to the present disclosure, an electrode sheet manufactured according to the method for manufacturing the electrode sheet may be provided, and a content of the volatile solvent remaining in the electrode sheet may range of about 10 ppm to about 100 ppm.

### BRIEF DESCRIPTION OF THE DRAWINGS

FIG. 1 is a schematic block diagram illustrating a system for manufacturing an electrode sheet according to the present disclosure.

FIG. 2 is a view illustrating a portion of a calendering device according to the present disclosure.

FIG. 3 is a flowchart for explaining a method for manufacturing an electrode sheet according to the present disclosure.

FIG. 4 is an SEM image obtained by photographing a surface of an electrode sheet obtained using the system for manufacturing the electrode sheet according to the present disclosure.

FIG. 5 is an SEM image obtained by photographing a surface of an electrode sheet obtained using the system for manufacturing the electrode sheet according to the present disclosure.

### DETAILED DESCRIPTION

Preferred embodiments of the present disclosure will be described below in more detail with reference to the accompanying drawings. A configuration or control method of the device described below is only for explaining embodiments of the present disclosure and is not intended to limit the scope of the present disclosure, and the same reference numbers used throughout the specification indicate the same components.

The use of the terms such as ‘first, second, and third’ in front of the components mentioned below is only to avoid confusion about the components to which they are referred, as well as has nothing to do with the order, importance, or master-slave relationship between the components. For example, the invention that includes only the second component without the first component may also be implemented.

As used herein, the terms of a singular form may include plural forms unless referred to the contrary.

The embodiments described herein may be modified in various other ways, and thus the technology according to an embodiment is not limited to embodiments described below. Furthermore, throughout the specification, the use of the words “comprises”, “provided with”, “contains”, or “has” does not exclude other elements, but rather indicates that other elements may be added, and also, these terms do not exclude elements, materials, or processes that are not additionally listed.

The numerical ranges used in this specification include all values within the lower and upper limit values, increments logically derived from the form and breadth of the defined range, all values that are double-limited, and all possible combinations of the upper and lower limit values of the numerical range limited in different forms.

Unless otherwise specifically defined in this specification, “about” may be considered as within 30%, 25%, 20%, 15%, 10%, or 5% of the specified value.

Hereinafter, the present disclosure will be described in detail. However, this is merely illustrative, and the present disclosure is not limited to a specific embodiment illustrated as an example of the present disclosure.

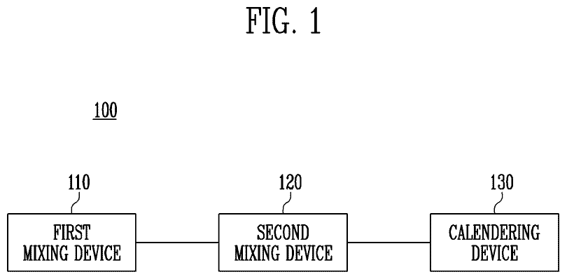

FIG. 1 is a schematic block diagram illustrating a system for manufacturing an electrode sheet according to the present disclosure.

Referring to FIG. 1, a system 100 for manufacturing an electrode sheet according to the present disclosure may include a first mixing device 110 that manufactures a binder composite, a second mixing device 120 that manufactures electrode powder, and a calendering device 130 that manufactures an electrode sheet by inputting the electrode powder and performing roll pressing on the electrode powder.

The system 100 for manufacturing the electrode sheet according to the present disclosure may be used to manufacture a dry-type electrode sheet and an electrode using the dry-type electrode sheet.

Generally, in the manufacturing of the electrode, an electrode active material and a binder were dispersed in a solvent to prepare slurry, and then the slurry was applied on an electrode current collector and dried to remove the solvent.

On the other hand, an object of the present disclosure is to manufacture the dry-type electrode sheet produced by the dry-type method. The electrode sheet may be manufactured using a mixture including a binder having an absorbed volatile solvent and an electrode active material. In detail, heat and a pressure may be applied to the binder, in which the volatile solvent is absorbed, to fiberize the binder, and thus, particles of the electrode active material may be bonded to each other to manufacture the electrode sheet that is maintained in a sheet shape without the need for a separate support such as a current collector. Here, since the volatile solvent is volatilized, there is no need to perform an additional drying process. Thereafter, the dry-type electrode sheet may be disposed on at least one surface of the electrode current collector and then be heated and pressed to manufacture the electrode.

Thus, a drying process for drying the solvent may be omitted, and the electrode sheet that is environmentally friendly may be manufactured, and the electrode may be manufactured using the electrode sheet.

Hereinafter, a method for preparing the binder composite will be described.

In an embodiment, the first mixing device 110 may mix the binder and the volatile solvent to prepare a binder composite.

In an embodiment, with respect to 100 parts by weight of the binder composite, the binder may be mixed in an amount of about 50 parts to about 80 parts by weight, and the volatile solvent may be mixed in an amount of about 20 parts to about 50 parts by weight. In an embodiment, the volatile solvent may be impregnated into the binder in the range of the parts by weight of the binder and the volatile solvent to promote the fiberization of the binder. When the fiberization of the binder is promoted, deformation of the electrode sheet may be prevented. As a result, tensile strength of the finally manufactured electrode sheet may increase. The electrode sheet may increase in tensile strength and thus may be maintained in its sheet shape even without the current collector. If a content of the binder is less than about 50 parts by weight per 100 parts by weight of the binder composite, there may be a limitation in which it is difficult to maintain the shape of the electrode sheet due to the low content of the binder. When the content of the binder exceeds about 80 parts by weight per 100 parts by weight of the binder composite, there is a limitation that electrode resistance increases excessively.

In addition, in the above range, the volatile solvent contained in the binder composite may serve as a lubricant in the second mixing device 120 to reduce abrasion of the second mixing device 120. The binder may be made of a material that is capable of being fibrous.

The binder is provided as particles in which fine fibers are bundled together. At a certain temperature, the fibers bundled together may be separated individually to form fine fibers. Such the fine fibers may be distributed on surfaces of the particles of the electrode active material to firmly bond the particles to each other, thereby providing the tensile strength to the electrode sheet and allowing the sheet to be maintained in its sheet shape. In addition, when manufacturing the electrode by laminating the electrode sheet on the surface of the electrode current collector, the electrode sheet may be firmly bonded to the surface of the electrode current collector.

The binder may include a polytetrafluoroethylene (PTFE) binder. The binder may include polyvinylidene fluoride (PVDF), poly(vinylidene fluoride-co-hexafluoropropylene), polyacrylonitrile, polymethyl methacrylate, acrylonitrile-butadiene rubber (NBR), polybutadiene rubber (BR), styrene-butadiene rubber (SBR), etc.

The volatile solvent may include an isoparaffinic hydrocarbon solvent. The isoparaffinic hydrocarbon solvent may be referred to as isoparaffin. The volatile solvent may be a mixture of isoalkanes having about 8 carbon atoms to about 10 carbon atoms and isoalkanes having about 9 carbon atoms to about 11 carbon atoms and may include isoalkanes having about 8 carbon atoms to about 11 carbon atoms. As the volatile solvent, ISOPAR-E prepared by Exxon Mobile may be used. However, this is merely an example, and the type of volatile solvent is not limited thereto.

A boiling point of the volatile solvent may be from about 99° C. to about 115° C.

A density of the volatile solvent may range of about 0.710 g/cc to about 0.726 g/cc. Here, the density may represent a density at about 15.6 degrees Celsius (C).

The viscosity of the volatile solvent may range of about 0.68 mm2/s to about 1.48 mm2/s. Here, the viscosity may represent a viscosity at about 25 degrees Celsius (° C.).

A relative evaporation rate of the volatile solvent may range of about 5.7 to about 370 when an evaporation rate of n-butyl acetate at about 25° C. is set to about 100.

In an embodiment, the first mixing device 110 may include a blender. According to an embodiment, the “blender” may represent a mixer of a batch type including a blade. According to an embodiment, the batch-type mixer may refer to a mixer that mixes a predetermined amount of material when the predetermined amount of material is inputted, and discharges the mixed material to the outside. According to an embodiment, the batch-type mixer may represent a mixer with a circulation structure in which a prescribed amount of material is inputted again after the mixed material is discharged to the outside.

In an embodiment, the first mixing device 110 may mix the binder with the volatile solvent for a period of time ranging of about 4 to about 8 minutes. During the aforementioned time range, the binder and the volatile solvent may be uniformly mixed. More specifically, the first mixing device 110 may mix the binder with the volatile solvent for a period of time ranging of about 5 minutes to about 8 minutes, of about 6 minutes to about 8 minutes, of about 6 times to about 7 minutes, or of about 7 minutes to about 8 minutes.

In an embodiment, the first mixing device 110 may mix the binder with the volatile solvent at room temperature.

In an embodiment, the first mixing device 110 may mix the binder and the volatile solvent at a speed of about 8,000 rpm (revolutions per minute) to about 12,000 rpm. During the aforementioned time range, the binder and the volatile solvent may be uniformly mixed. More specifically, the first mixing device 110 may mix the volatile solvent at a speed of about 8,000 rpm to about 10,000 rpm, about 9,000 rpm to about 12,000 rpm, about 9,000 rpm to about 10,000 rpm, or about 10,000 rpm to about 12,000 rpm.

In an embodiment, the binder composite may be aged at a preset temperature for a preset time. In an embodiment, the binder composite may be aged at a preset temperature for a preset time.

The preset temperature may be from about 20° C. to about 40° C. At the preset temperature, the volatile solvent may be effectively impregnated (absorbed) by the binder. More specifically, the preset temperature may range of about 20° C. to about 30° C., or of about 30° C. to about 40° C.

The preset time may be about 6 hours or more. At the preset time, the volatile solvent may be effectively absorbed (impregnated) by the binder. More specifically, the preset time may range of about 6 hours to about 40 hours, of about 6 hours to about 38 hours, of about 6 hours to about 36 hours, of about 6 hours to about 34 hours, of about 6 hours to about 30 hours, of about 8 hours to about 40 hours, of about 8 hours to about 38 hours, of about 8 hours to about 36 hours, of about 8 hours to about 34 hours, or of about 8 hours to about 30 hours.

Hereinafter, a method for manufacturing electrode powder is described.

The second mixing device 120 may mix the binder composite, the electrode active material, and the conductive material to manufacture electrode powder. The electrode powder may be powder of a mixture in which the binder composite, the electrode active material, and the conductive material are mixed.

With respect to 100 parts by weight of the electrode powder, the electrode active material may be about 80 parts by weight to about 99 parts by weight. In particular, the electrode active material may be about 85 parts to about 99 parts by weight, about 90 parts to about 99 parts by weight, about 95 parts to about 99 parts by weight, or about 96 parts to about 98 parts by weight.

With respect to 100 parts by weight of the electrode powder, the conductive material may be about 0.1 parts by weight to about 1 part by weight. In particular, the conductive material may be about 0.1 parts to about 0.9 parts by weight, about 0.2 parts to about 0.9 parts by weight, about 0.3 parts to about 0.9 parts by weight, or about 0.4 parts to about 0.9 parts by weight.

With respect to 100 parts by weight of the electrode powder, the binder composite may be about 1.5 parts to about 3.5 parts by weight. In particular, the binder composite may be about 2 parts to about 3.5 parts by weight, about 2.5 parts to about 3.5 parts by weight, about 3 parts to about 3.5 parts by weight, or about 2 parts to about 2.5 parts by weight.

More specifically, with respect to 100 parts by weight of the electrode powder, the electrode active material may be mixed in an amount of about 97.5 parts by weight, the conductive material may be mixed in an amount of about 0.5 part by weight, and the binder composite may be mixed in an amount of about 2 parts by weight.

In an embodiment, the electrode active material may refer to a positive electrode active material. The positive electrode active material may include lithium-nickel metal oxide. The lithium-nickel metal oxide may further include at least one of cobalt (Co), manganese (Mn), or aluminum (Al).

The conductive material may be added to enhance conductivity of the active material layer and/or mobility of lithium ions or electrons. For example, the conductive material may include carbon-based conductive materials such as graphite, carbon black, acetylene black, ketjen black, graphene, carbon nanotubes (CNTs), vapor-grown carbon fiber (VGCF), carbon fibers, etc., and/or metal-based conductive materials including perovskite materials such as tin, stannic oxide, titanium oxide, LaSrCoO₃, and LaSrMnO₃, but is not limited thereto.

According to an exemplary embodiment, the electrode active material may include a negative electrode active material. As the negative electrode active material, a material capable of adsorbing and desorbing lithium ions may be used. For example, as the negative electrode active material, carbon-based materials such as crystalline carbon, amorphous carbon, carbon composites, and carbon fibers, lithium metals, lithium alloys, silicon (Si)-containing materials, or tin (Sn)-containing materials may be used.

Examples of the amorphous carbon may include hard carbon, soft carbon, coke, mesocarbon microbead (MCMB), and mesophase pitch-based carbon fiber (MPCF).

As examples of the crystalline carbon, carbonaceous carbons such as natural graphite, artificial graphite, graphitized coke, graphitized MCMB, and graphitized MPCF may be used.

The lithium metal may be a pure lithium metal or a lithium metal with a protective layer disposed to inhibit dendrite growth, etc. In an embodiment, a lithium metal-containing layer deposited or coated on the negative electrode current collector may be used as a negative electrode active material layer. In an embodiment, a lithium thin film layer may also be used as the positive electrode active material layer.

As elements contained in the lithium alloy, aluminum, zinc, bismuth, cadmium, antimony, silicon, lead, tin, gallium, or indium may be used.

The silicon-containing material may provide more increasing dose characteristics. The silicon-containing material may include Si, SiOx (0<x<2), metal-doped SiOx (0<x<2), silicon-carbon composites, etc. The metal may include lithium and/or magnesium, and the metal-doped SiOx (0<x<2) may include metal silicate.

The second mixing device 120 may represent a continuous slurry mixer. The continuous mixer may refer to a mixer that automatically inputs a preset amount of material at preset time intervals, mixes the materials, and discharges the mixed material.

In an embodiment, the continuous slurry mixer may include a twin-screw extruder. According to an embodiment, the twin-screw extruder may represent a mixing device in which two screws are engaged with each other or rotate independently while mixing materials.

In an embodiment, a temperature at which the second mixing device 120 mixes the binder composite, the electrode active material, and the conductive material may be about 60° C. to about 100° C. In the temperature range, the fibrous binder composite may be dispersed on the surfaces of the particles of the electrode active material to bond the particles to each other and maintain the sheet shape when forming the electrode sheet. More specifically, the temperature at which the second mixing device 120 mixes the binder composite, the electrode active material, and the conductive material may be range of about 60° C. to about 90° C., of about 60° C. to about 80° C., of about 60° C. to about 70° C., of about 70° C. to about 100° C., of about 70° C. to about 90° C., of about 70° C. to about 80° C., of about 80° C. to about 100° C., or of about 80° C. to about 90° C.

In an embodiment, a mixing speed of the second mixing device 120 for mixing the binder composite, the electrode active material, and the conductive material may range of about 8,000 rpm (revolutions per minute) to about 12,000 rpm (revolutions per minute). When the speed is less than about 8,000 rpm (revolutions per minute), a sufficient shear pressure may not be provided, and thus the fiberization of the binder may not occur sufficiently. When the speed exceeds about 12,000 rpm (revolutions per minute), there is no additional effect on enhancing the fiberization of the binder, instead, it may cause a limitation that leads to breakage of the electrode sheet. More specifically, the mixing speed of the second mixing device 120 for mixing the binder composite, the electrode active material, and the conductive material may range of about 8,000 rpm to about 10,000 rpm, of about 9,000 rpm to about 12,000 rpm, of about 9,000 rpm to about 10,000 rpm, or of about 10,000 rpm to about 12,000 rpm.

In an embodiment, a discharge rate per hour of the second mixing device 120 may be about 40 kg/h to about 60 kg/h. More specifically, the discharge rate per hour of the second mixing device 120 may range of about 40 kg/h to about 50 kg/h or of about 50 kg/h to about 60 kg/h.

The volatile solvent contained in the binder composite may serve as a lubricant in the second mixing device 120 to reduce abrasion of the second mixing device 120.

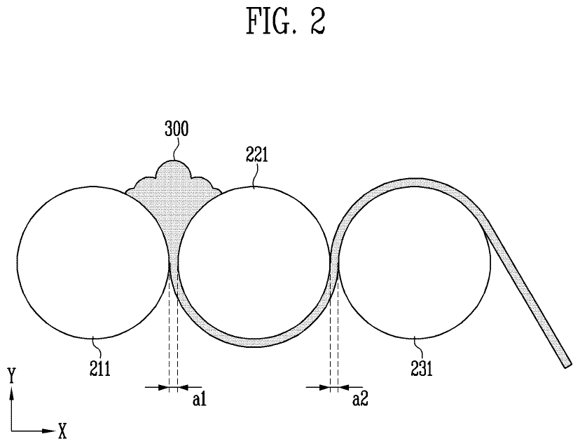

Hereinafter, a method of manufacturing the electrode sheet will be described with reference to FIG. 2. FIG. 2 is a view illustrating a portion of the calendering device according to the present disclosure.

The calendaring device 130 may manufacture the electrode sheet by roll-pressing the electrode powder.

The calendaring device 130 may include a plurality of rolls 211, 221, and 231 that rotate to move the electrode powder while pressing the electrode powder. For example, the number of plurality of rolls 211, 221, and 231 may include three. However, this is merely an example, and the number of plurality of rolls 211, 221, and 231 included in the calendering device 130 according to the present disclosure is not limited thereto.

In an embodiment, the plurality of rolls 211, 221, and 231 may include a first roll 211, a second roll 221, and a third roll 231. In an embodiment, the electrode powder 300 may be inputted between the plurality of rolls 211, 221, and 231.

In an embodiment, an interval between the plurality of rolls 211, 221, and 231 may be set differently or equally from each other.

In an embodiment, a second interval a2 between the second roll 221 and the third roll 231 may be less than a first interval a1 between the first roll 211 and the second roll 221. Thus, when the second interval a2 is less than the first interval a1, a higher pressure may be applied to the electrode powder between the second roll 221 and the third roll 231, which are spaced the second interval a2 from each other, than a pressure applied between the first roll 211 and the second roll 221. As a result, the fiberization of the binder may be further improved, and thus, the electrode sheet that is maintained in the sheet shape without the current collector may be obtained.

According to an embodiment, the first interval a1 may be about 200 μm to about 300 μm. When the first interval a1 exceeds about 300 μm, the pressure applied to the electrode powder may be insufficient, resulting in failure to form the electrode sheet. When the first interval a1 is less than about 200 μm, an excessive pressure may be applied to the electrode powder to cause cracks or tearing in the electrode sheet.

According to an embodiment, the second interval a2 may be about 100 μm to about 200 μm. When the second interval a2 exceeds about 200 μm, the pressure applied to the electrode powder may be insufficient, resulting in failure to form the electrode sheet. When the second interval a2 is less than about 100 μm, an excessive pressure may be applied to the electrode powder to cause cracks or tearing in the electrode sheet.

In an embodiment, the speeds at which the plurality of rolls 211, 221, and 231 rotate may be different from each other or the same.

In an embodiment, a ratio of the first speed at which the first roll 211 and the second roll 221 rotate to the second speed at which the second roll 221 and the third roll 231 rotate may range of about 1:1.2 to about 1:1.5. When the ratio of the first speed to the second speed is less than about 1:1.2, the tensile strength of the electrode sheet may decrease, and when the ratio exceeds about 1:1.5, an excessive shear pressure may cause wrinkles to form on a surface of the electrode sheet, or the electrode sheet may be broken. More specifically, the ratio of the first speed to the second speed may range of about 1:1.2 to about 1:1.4, of about 1:1.2 to about 1:1.3, of about 1:1.3 to about 1:1.4, of about 1:1.3 to about 1:1.5, or of about 1:1.4 to about 1:1.5. In an embodiment, certain heat may be applied to the calendaring device 130. In an embodiment, when heat is applied to the calendaring device 130, the heat may be provided to the electrode powder to promote the fiberization of the binder.

In an embodiment, the calendaring device 130 may manufacture the electrode sheet by roll-pressing the electrode powder at a temperature of about 110° C. to about 130° C. At the above-described temperature range, the fiberization of the binder may be promoted. As a result, the tensile strength of the electrode sheet manufactured within the temperature range may increase. More specifically, the calendaring device 130 may manufacture the electrode sheet by roll-pressing the electrode powder at a temperature of about 110° C. to about 120° C. or about 120° C. to about 130° C.

In an embodiment, a thickness of the electrode sheet may be about 100 μm to about 500 μm. When the thickness of the electrode sheet is less than about 100 μm, the tensile strength of the electrode sheet may be insufficient, resulting in breakage. On the other hand, when the thickness exceeds about 500 μm, the components forming the electrode sheet may not be uniformly mixed. More specifically, the thickness of the electrode sheet may range of about 100 μm to about 400 μm, of about 100 μm to about 300 μm, of about 100 μm to about 200 μm, of about 200 μm to about 500 μm, of about 200 μm to about 400 μm, of about 200 μm to about 300 μm, of about 300 μm to about 500 μm, of about 300 μm to about 400 μm, or of about 400 μm to about 500 μm.

In an embodiment, at least a portion of the volatile solvent may be volatilized while roll-pressing the electrode powder using the calendering device 130. In an embodiment, since the volatile solvent is volatilized, the drying process for removing the solvent may be omitted.

In an embodiment, an amount of residual solvent in the electrode sheet may be about 100 ppm or less. When the amount of residual solvent exceeds about 100 ppm, degradation of the battery cell manufactured using the electrode sheet may occur. More specifically, the amount of residual solvent in the electrode sheet manufactured by the method for manufacturing the electrode sheet according to the present disclosure may range of about 10 ppm to about 100 ppm.

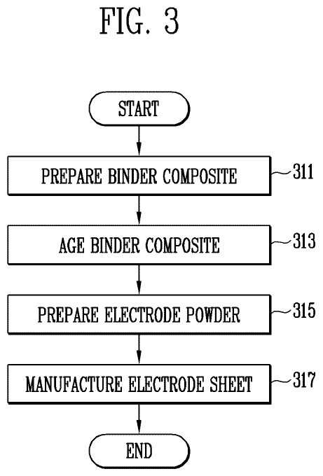

FIG. 3 is a flowchart for explaining a method for manufacturing an electrode sheet according to the present disclosure.

Referring to FIG. 3, a method for manufacturing an electrode sheet using the electrode sheet manufacturing system 100 according to the present disclosure may include a step (311) of manufacturing a binder composite by mixing a binder and a volatile solvent using a first mixing device 110. According to an embodiment, the first mixing device 110 may comprises a blender that accommodating and rotating the binder and a volatile solvent.

For example, a preset time may range of about 4 minutes to about 8 minutes, a preset temperature may be room temperature, and a preset speed may range of about 8.000 rpm (revolutions per minute) to about 12,000 rpm (revolutions per minute).

The method for manufacturing the electrode sheet using the electrode sheet manufacturing system 100 according to the present disclosure may include a step (313) of aging the binder composite at the preset temperature for the preset time.

In an embodiment, the preset time may be about 6 hours or more, and the preset temperature may range of about 20° C. to about 40° C.

In an embodiment, on the basis of the step of aging the binder composite, the binder may be impregnated (absorbed) into the volatile solvent.

The method for manufacturing the electrode sheet using the manufacturing system 100 according to the present disclosure may include a step (315) of manufacturing electrode powder using a second mixing device 120. According to an embodiment, the second mixing device 120 may include a continuous slurry mixer that mixes the binder composite, the electrode active material, and the conductive material.

In an embodiment, the preset temperature may range of about 60° C. to about 100° C., the preset speed may range of about 8,000 rpm (per minute) to about 12,000 rpm (per minute), and the preset amount of material discharged per hour may range of about 40 kg/h to about 60 kg/h.

The method for manufacturing the electrode sheet using the system 100 for manufacturing the electrode sheet according to the present disclosure may include a step (317) of manufacturing the electrode sheet by roll-pressing the electrode powder using the calendering device 130.

In an embodiment, the step of manufacturing the electrode sheet by roll-pressing the electrode powder using the calendering device 130 may include a step of inputting the electrode powder between rolls disposed at a first interval among the plurality of rolls included in the calendering device 130 and rolls disposed at a second interval that is less than or equal to the first interval. The plurality of rolls may rotate to move the electrode powder while pressing the electrode powder.

In an embodiment, the first interval may be about 200 μm to about 300 μm, and the second interval may be about 100 μm to about 200 μm.

In an embodiment, a speed of each of the rolls disposed at the first interval and a speed of each of the rolls disposed at the second interval may be different from each other. In an embodiment, a ratio of the speed of each of the rolls disposed at the first interval to a speed of each of the rolls disposed at the second interval may range of about 1:1.2 to about 1:1.5.

In an embodiment, the step of manufacturing the electrode sheet by roll-pressing the electrode powder using the calendering device 130 may be performed at a temperature of about 110° C. to about 130° C.

In an embodiment, at least a portion of the volatile solvent may be volatilized while roll-pressing the electrode powder using the calendaring device.

In an embodiment, a content of the volatile solvent remaining in the electrode sheet that is roll-pressed may range of about 10 ppm to about 100 ppm.

Hereinafter, embodiments of the present disclosure will be further described with reference to specific examples. Embodiments and Comparative Examples included in experimental examples are merely illustrative of the present disclosure and are not intended to limit the appended claims. It is obvious to those skilled in the art that various changes and modifications can be made to the examples within the scope of the disclosure and the spirit of the present disclosure, and it is also obvious that such variations and modifications fall within the scope of the appended claims.

### PREPARATION ACCORDING TO EMBODIMENT AND COMPARATIVE EXAMPLES

### Embodiment 1

A binder composite was prepared by mixing a binder and a volatile solvent using a blender. With respect to 100 parts by weight of the binder composite, about 50 parts by weight of the binder and about 50 parts by weight of the volatile solvent were mixed. Here, polytetrafluoroethylene (PTFE) prepared by Chemours was used as the binder, and ISOPAR-E prepared by Exxon Mobile was used as the volatile solvent. A mixing time was set to about 6 minutes, a mixing speed was set to about 9000 rpm, and a mixing temperature was set to 23 degrees Celsius (° C.).

The binder composite was aged at room temperature for about 24 hours.

An electrode powder was prepared by mixing a positive electrode active material, a conductive material, and the binder composite using a twin-screw extruder. With respect to 100 parts by weight of the electrode powder, about 97.5 parts by weight of the positive electrode active material, about 0.5 part by weight of the conductive material, and about 2 parts by weight of the binder composite were mixed to manufacture the electrode powder. Here, an NCM-based lithium oxide, specifically nickel-cobalt-manganese (NCM) 811 with a ratio of nickel, cobalt, and manganese of about 80:10:10 by weight was used as the positive electrode active material, and carbon nano tube (CNT) powder 10B prepared by JEIO Corporation was used as the conductive material. A mixing temperature was set at about 80 degrees Celsius (° C.), a mixing speed was set to about 1,000 rpm, and a discharge rate was set to about 40 kg/h. CDS172-14BW prepared by Ecopro was used as the positive electrode active material.

The electrode sheet was manufactured by roll-pressing the electrode powder at about 120° C. using a calendering device 130 in which three rolls, i.e., a first roll 211, a second roll 221, and a third roll 231, were disposed in sequence (see FIG. 2). A thickness of the electrode sheet may be about 200 μm. An interval between the first roll 211 and the second roll 221 was set to about 240 μm, and an interval between the second roll 221 and the third roll 231 was set to about 180 μm. A rotation speed of the first roll 211 was set to about 1 m/min, a rotation speed of the second roll 221 was set to about 1.2 m/min, and a rotation speed of the third roll 231 was set to about 1.4 m/min. The calendaring device 130 used KRM-80B manufactured by KMTech Co., Ltd.

### Embodiment 2

A binder composite was prepared by mixing a binder and a volatile solvent using a blender. With respect to 100 parts by weight of the binder composite, about 80 parts by weight of the binder and about 20 parts by weight of the volatile solvent were mixed. Here, polytetrafluoroethylene (PTFE) prepared by Chemours was used as the binder, and ISOPAR-E prepared by Exxon Mobile was used as the volatile solvent. A mixing time was set to about 6 minutes, a mixing speed was set to about 9000 rpm, and a mixing temperature was set to 23 degrees Celsius (C).

The binder composite was aged at room temperature for about 24 hours.

An electrode powder was prepared by mixing a positive electrode active material, a conductive material, and the binder composite using a twin-screw extruder. With respect to 100 parts by weight of the electrode powder, about 97.5 parts by weight of the positive electrode active material, about 0.5 part by weight of the conductive material, and about 2 parts by weight of the binder composite were mixed to manufacture the electrode powder. Here, an NCM-based lithium oxide, specifically nickel-cobalt-manganese (NCM) 811 with a ratio of nickel, cobalt, and manganese of about 80:10:10 by weight was used as the positive electrode active material, and carbon nano tube (CNT) powder 10B prepared by JEIO Corporation was used as the conductive material. A mixing temperature was set at about 80 degrees Celsius (° C.), a mixing speed was set to about 1,000 rpm, and a discharge rate was set to about 40 kg/h. CDS172-14BW prepared by Ecopro was used as the positive electrode active material.

The electrode sheet was manufactured by roll-pressing the electrode powder at about 120° C. using a calendering device 130 in which three rolls, i.e., a first roll 211, a second roll 221, and a third roll 231, were disposed in sequence (see FIG. 2). A thickness of the electrode sheet may be about 200 μm. An interval between the first roll 211 and the second roll 221 was set to about 240 μm, and an interval between the second roll 221 and the third roll 231 was set to about 180 μm. A rotation speed of the first roll 211 was set to about 1 m/min, a rotation speed of the second roll 221 was set to about 1.2 m/min, and a rotation speed of the third roll 231 was set to about 1.4 m/min. The calendaring device 130 used KRM-80B manufactured by KMTech Co., Ltd.

### Comparative Example 1

An electrode powder was prepared by mixing a positive electrode active material, a conductive material, and a binder that is not impregnated with a volatile solvent using a twin-screw extruder. With respect to about 100 parts by weight of the electrode powder, about 97.5 parts by weight of the positive electrode active material, about 0.5 parts by weight of the conductive material, and about 2 parts by weight of the binder were mixed.

Here, nickel-cobalt-manganese (NCM) 811 with a ratio of nickel, cobalt, and manganese of about 80:10:10 by weight was used as the positive electrode active material, CNT powder of 10B prepared by JEIO Corporation was used as the conductive material, and polytetrafluoroethylene (PTFE) prepared by Chemours Corporation was used as the binder. A mixing temperature was set at about 80 degrees Celsius (C), a mixing speed was set to about 1,000 rpm, and a discharge rate was set to about 40 kg/h. CDS172-14BW prepared by Ecopro was used as the positive electrode active material.

The electrode sheet was manufactured by roll-pressing the electrode powder at about 120° C. using a calendering device 130 in which three rolls, i.e., a first roll 211, a second roll 221, and a third roll 231, were disposed in sequence (see FIG. 2). A thickness of the electrode sheet may be about 200 μm. An interval between the first roll 211 and the second roll 221 was set to about 240 μm, and an interval between the second roll 221 and the third roll 231 was set to about 180 μm. A rotation speed of the first roll 211 was set to about 1 m/min, a rotation speed of the second roll 221 was set to about 1.2 m/min, and a rotation speed of the third roll 231 was set to about 1.4 m/min. The calendaring device 130 used KRM-80B manufactured by KMTech Co., Ltd.

### Comparative Example 2

A binder composite was prepared by mixing a binder and a volatile solvent using a blender. With respect to 100 parts by weight of the binder composite, about 50 parts by weight of the binder and about 50 parts by weight of the volatile solvent were mixed. Here, polytetrafluoroethylene (PTFE) prepared by Chemours was used as the binder, and ISOPAR-E prepared by Exxon Mobile was used as the volatile solvent. A mixing time was set to about 6 minutes, a mixing speed was set to about 9000 rpm, and a mixing temperature was set to 23 degrees Celsius (C).

The binder composite was aged at room temperature for about 1 hours.

An electrode powder was prepared by mixing a positive electrode active material, a conductive material, and the binder composite using a twin-screw extruder. With respect to 100 parts by weight of the electrode powder, about 97.5 parts by weight of the positive electrode active material, about 0.5 part by weight of the conductive material, and about 2 parts by weight of the binder composite were mixed to manufacture the electrode powder. Here, an NCM-based lithium oxide, specifically nickel-cobalt-manganese (NCM) 811 with a ratio of nickel, cobalt, and manganese of about 80:10:10 by weight was used as the positive electrode active material, and carbon nano tube (CNT) powder 10B prepared by JEIO Corporation was used as the conductive material. A mixing temperature was set at about 80 degrees Celsius (° C.), a mixing speed was set to about 1,000 rpm, and a discharge rate was set to about 40 kg/h. CDS172-14BW prepared by Ecopro was used as the positive electrode active material.

The electrode sheet was manufactured by roll-pressing the electrode powder at about 120° C. using a calendering device 130 in which three rolls, i.e., a first roll 211, a second roll 221, and a third roll 231, were disposed in sequence (see FIG. 2). A thickness of the electrode sheet may be about 200 μm. An interval between the first roll 211 and the second roll 221 was set to about 240 μm, and an interval between the second roll 221 and the third roll 231 was set to about 180 μm. A rotation speed of the first roll 211 was set to about 1 m/min, a rotation speed of the second roll 221 was set to about 1.2 m/min, and a rotation speed of the third roll 231 was set to about 1.4 m/min. The calendaring device 130 used KRM-80B manufactured by KMTech Co., Ltd.

### Comparative Example 3

A binder composite was prepared by mixing a binder and a volatile solvent using a blender. With respect to 100 parts by weight of the binder composite, about 20 parts by weight of the binder and about 80 parts by weight of the volatile solvent were mixed. Here, polytetrafluoroethylene (PTFE) prepared by Chemours was used as the binder, and

ISOPAR-E prepared by Exxon Mobile was used as the volatile solvent. A mixing time was set to about 6 minutes, a mixing speed was set to about 9000 rpm, and a mixing temperature was set to 23 degrees Celsius (C).

The binder composite was aged at room temperature for about 24 hours.

An electrode powder was prepared by mixing a positive electrode active material, a conductive material, and the binder composite using a twin-screw extruder. With respect to 100 parts by weight of the electrode powder, about 97.5 parts by weight of the positive electrode active material, about 0.5 part by weight of the conductive material, and about 2 parts by weight of the binder composite were mixed to manufacture the electrode powder. Here, an NCM-based lithium oxide, specifically nickel-cobalt-manganese (NCM) 811 with a ratio of nickel, cobalt, and manganese of about 80:10:10 by weight was used as the positive electrode active material, and carbon nano tube (CNT) powder 10B prepared by JEIO Corporation was used as the conductive material. A mixing temperature was set at about 80 degrees Celsius (° C.), a mixing speed was set to about 1,000 rpm, and a discharge rate was set to about 40 kg/h. CDS172-14BW prepared by Ecopro was used as the positive electrode active material.

The electrode sheet was manufactured by roll-pressing the electrode powder at about 120° C. using a calendering device 130 in which three rolls, i.e., a first roll 211, a second roll 221, and a third roll 231, were disposed in sequence (see FIG. 2). A thickness of the electrode sheet may be about 200 μm. An interval between the first roll 211 and the second roll 221 was set to about 240 μm, and an interval between the second roll 221 and the third roll 231 was set to about 180 μm. A rotation speed of the first roll 211 was set to about 1 m/min, a rotation speed of the second roll 221 was set to about 1.2 m/min, and a rotation speed of the third roll 231 was set to about 1.4 m/min. The calendaring device 130 used KRM-80B manufactured by KMTech Co., Ltd.

A size of the prepared electrode powder, tensile strength of the finally prepared electrode sheet, and an amount of residual solvent of the volatile solvent of the electrode sheet in Embodiments 1 to 2 and Comparative Examples 1 to 3 are as shown in Table 1 below.

TABLE 1

| | Size of | Tensile strength | Residual |
|---|---|---|---|
| | electrode | of electrode | solvent amount |
| Items | powder (μm) | sheet (N/mm²) | (ppm) |
| Embodiment 1 | 15.63 | 1.05 | 89 |
| Embodiment 2 | 13.24 | 0.51 | 51 |
| Comparative | Immeasurable | Immeasurable | — |
| Example 1 | | | |
| Comparative | Immeasurable | Immeasurable | Immeasurable |
| Example 2 | | | |
| Comparative | 15.52 | 0.91 | 455 |
| Example 3 | | | |

Referring to Embodiments 1 and Comparative Example 2, it may be seen that as the aging time of the binder composite increases, the binder is more effectively impregnated (absorbed) into the volatile solvent to promote the fiberization of the binder. Thus, the electrode sheet manufactured according to Embodiment 1 had excellent tensile strength. Comparative Example 2 showed that since the binder composite was aged for only a short period of time, the volatile solvent was not be effectively impregnated into the binder. Thus, abrasion occurred in the second mixing device 120. For this, it was not possible to measure the powder size of the electrode powder, the tensile strength of the electrode sheet, and the amount of residual solvent indicating the amount of volatile solvent in the electrode sheet.

Comparative Example 1 illustrates an example in which the electrode powder and the electrode sheet were manufactured using the binder to which no volatile solvent is inputted. For this, the abrasion occurred in the second mixing device 120, and it was not possible to measure the powder size of the electrode powder and the tensile strength of the electrode sheet.

Referring to Embodiment 1 and Comparative Example 3, the higher the weight ratio of the volatile solvent, the greater the amount of residual solvent in the electrode sheet. When the amount of residual solvent in the electrode sheet exceeds the amount of residual solvent specified in an embodiment of the present disclosure, performance of the battery cell manufactured using the electrode sheet may be reduced. In particular, if the amount of residual solvent exceeds the limit specified in an embodiment of the present disclosure, degradation of the battery cell manufactured using the electrode sheet may occur.

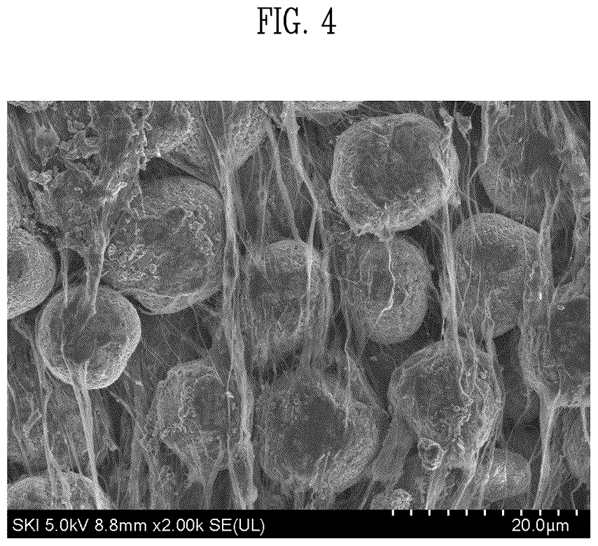

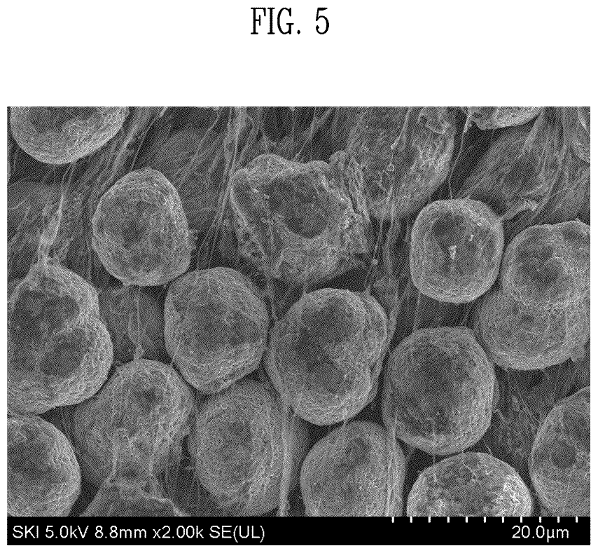

FIG. 4 is an SEM image obtained by photographing a surface of an electrode sheet obtained using the system for manufacturing the electrode sheet according to the present disclosure. FIG. 5 is an SEM image obtained by photographing a surface of an electrode sheet obtained using the system for manufacturing the electrode sheet according to the present disclosure.

In more detail, FIG. 4 is an SEM image of a surface of the electrode sheet according to Embodiment 1. In more detail, FIG. 5 is an SEM image of a surface of the electrode sheet according to Embodiment 2.

In Embodiment 1, a content of the volatile solvent is about 50 parts by weight per 100 parts by weight of the prepared binder composite.

In Embodiment 2, a content of the volatile solvent is about 20 parts by weight per 100 parts by weight of the prepared binder composite.

That is, a content of the volatile solvent in Embodiment 1 is higher than that in Embodiment 2.

Referring to FIGS. 4 and 5, it may be seen that a degree of fiberization of the binder in Embodiment 1 is greater than a degree of fiberization of the binder in Embodiment 2. In an embodiment, the volatile solvent may promote the fiberization of the binder. When the fiberization of the binder is promoted, the fiberized binder may firmly bind the particles of the electrode active material. Thus, the shape of the electrode sheet may be maintained without the current collector to prevent deformation of the electrode sheet.

According to an embodiment of the present disclosure, the quality of the electrode sheet may be improved.

According to another embodiment of the present disclosure, the frictional force of the electrode powder may be reduced.

According to another embodiment of the present disclosure, the abrasion of the equipment for manufacturing the electrode may be reduced.

According to another embodiment of the present disclosure, the manufacturing costs of the electrode sheet may be reduced.

According to another embodiment of the present disclosure, the tensile strength may increase.

The present disclosure may be modified in various forms, and thus the scope of the present disclosure is not limited to the above-described embodiments. Therefore, if the modified embodiment includes the components of the claims of this disclosure, it should be considered to fall within the scope of the claims of this disclosure.

What is claimed is:

1. A method for manufacturing an electrode sheet, the method comprising:
mixing a binder and a volatile solvent using a first mixing device to prepare a binder composite;
mixing the binder composite, an electrode active material, and a conductor using a second mixing device to prepare electrode powder; and
roll-pressing the electrode powder using a calendering device to prepare the electrode sheet.

2. The method of claim 1, further comprising aging the binder composite at a preset temperature for a preset time.

3. The method of claim 2, wherein the preset time is about 6 hours or more.

4. The method of claim 2, wherein the volatile solvent is impregnated into the binder on the basis of the aging of the binder composite.

5. The method of claim 1, wherein the first mixing device comprises a blender that accommodating and rotating the binder and the volatile solvent.

6. The method of claim 1, wherein the second mixing device comprises a continuous slurry mixer that mixes the binder composite, the electrode active material, and the conductive material.

7. The method of claim 1, wherein the calendaring device comprises a plurality of rolls that rotate to move the electrode powder while pressing the electrode powder.

8. The method of claim 7, wherein the roll-pressing of the electrode powder to prepare the electrode sheet comprises inputting the electrode powder between rolls of the plurality of rolls, which are disposed at a first interval, and between rolls of the plurality of rolls, which are disposed at a second interval less than or equal to the first interval.

9. The method of claim 8, wherein a speed of each of the rolls disposed at the first interval and a speed of each of the rolls disposed at the second interval are different from each other.

10. The method of claim 1, wherein at least a portion of the volatile solvent is volatilized while roll-pressing the electrode powder using the calendaring device.

11. The method of claim 10, wherein a content of the volatile solvent remaining in the electrode sheet roll-pressed using the calendaring is about 10 ppm to about 100 ppm.

12. The method of claim 1, wherein the volatile solvent comprises an isoparaffinic hydrocarbon solvent.

13. The method of claim 1, wherein a boiling point of the volatile solvent ranges of about 99° C. to 193° C.,
a density of the volatile solve ranges of about 0.710 g/cc to about 0.726 g/cc,
a viscosity of the volatile solvent ranges of about 0.68 mm2/s to about 1.48 mm2/s, and
a relative evaporation rate of the volatile solvent ranges of about 5.7 to about 370 when an evaporation rate of n-butyl acetate (n-BuAc) is about 100.

14. The method of claim 1, wherein, with respect to 100 parts by weight of the binder composite, the binder has about 50 parts to about 80 parts by weight, and
the volatile solvent has about 20 parts to about 50 parts by weight.

15. An electrode sheet manufactured according to claim 1,
wherein a content of the volatile solvent remaining in the electrode sheet ranges of about 10 ppm to about 100 ppm.
